(19) United States
(12) Patent Application Publication
(10) Pub. No.: US 2009/0214792 A1
(43) Pub. Date: Aug. 27, 2009

(54) Deglosser machine

(76) Inventor: Cameron Kruse, Colorado Springs, CO (US)

Correspondence Address: Cameron Kruse, 14745 Camproberts Ct, Colorado Springs, CO, 80908, US

(21) Appl. No.: 12/378,924

(22) Filed: Feb. 21, 2009

Related U.S. Application Data
(60) Provisional application No. 61/066,848, filed on Feb. 22, 2008.

(51) Int. Cl. B05D 3/12; B05C 13/02

(52) U.S. Cl. 427/346; 118/56

(57) ABSTRACT

In one embodiment, a deglosser includes a deglossing agent reservoir and a horizontal base plate having an applicator case with an applicator such as a chamois. The chamois receives a deglossing agent and applies the agent to an object such as a baseball. Sponges or other similar devices may be used in addition to, or in replacement of, a chamois. The object is received between a plurality of manipulators. The manipulators can be movable wheels which are used for spinning the object in different axes for a predetermined amount of time. The agent can be applied directly to the object or to the applicator which then applies it to the object. As the object is manipulated, the agent is distributed across the object In this manner, the object is deglossed and covered completely with a uniform amount of agent for consistent color and moisture.

### CROSS-REFERENCE TO RELATED APPLICATIONS

This application claims benefit of U.S. Provisional Application No. 61/066,848, entitled “Baseball Deglosser Machine For Mudding a Baseball” and filed on Feb. 22, 2008, which is specifically incorporated herein by reference for all that it discloses and teaches.

### TECHNICAL FIELD

The invention relates generally to deglosser equipment, and more particularly, but not by way of limitation, to a deglosser device that can be used in the baseball industry to apply a uniform amount of mud to a baseball. Application of various embodiments of the device to address other deglossing needs is contemplated.

### BACKGROUND

The game of baseball has been played—with some variation—for over two centuries. During that time, many changes, innovations, and improvements to the game have been implemented. One such change occurred in 1920 after a Cleveland Indians player was hit in the head and killed by a pitch. Although tragic, this accident is not surprising considering he could not see the ball. At that time, there were no standards in place that would ensure a consistent color of a baseball. During a game it was considered part of a pitcher's job to scuff and “dirty up” the baseball, often using mud and chewing tobacco. This practice, combined with the fact that very few baseballs would be used in an entire game, resulted in very dark baseballs. Since the ball did not reflect much light, the eye had a much harder time tracking the ball causing it to appear to move erratically on the way to the plate. Historians presume that the baseball that killed the Cleveland player was extremely dark and almost impossible for him to see, which would explain his unenthusiastic effort to get out of the way.

As one would expect, this incident initiated several rule changes regarding the consistency and look of the baseball. The first of these changes was a rule stating that the baseball must be changed out regularly, whenever the ball was scuffed, or hit out of play. This rule eliminated the dark baseball that killed Ray Chapman, but also created its own problems.

Pitchers began complaining that the frequent switching out of baseballs introduced very glossy balls into play. In 1938, Lena Blackburne, an entrepreneur and third base coach of the Philadelphia Athletics, listened to the complaints of his pitchers. He devised a special mud that came from the Delaware River. It was treated with special ingredients to ensure consistent smooth texture to the mud. This mud was rubbed on all of the baseballs before the game and deglossed them to the new standards of Major League Baseball. Soon after Lena Blackburne's “magic mud” was made public, Major League Baseball added rule 3.01(c). This rule states that, “The umpire shall inspect the baseballs and ensure they are regulation baseballs and that they are properly rubbed so that the gloss is removed.”

This rule is still in effect today. Before every game, a clubhouse assistant, usually the batboy, will be in charge of mudding 60-80 baseballs. Although the gloss is still being removed, just as it was 80 years ago, it has been discovered that this rubbing process creates numerous inconsistencies. These inconsistencies include, but are not limited to, weight variation, moisture variation, texture variation, and color variation between baseballs. Although each of these inconsistencies can influence the outcome of a baseball game, color variation is the most prevalent. This color variation is a result of the applicator's inability to apply the same amount of mud to every baseball. One person may degloss the baseball with very little mud. The next baseball may be deglossed with a lot of mud. This is what causes the color variation. The first ball absorbed very little mud; therefore its coloring is very close to white. The second ball absorbed more mud than the first; so it is dark brown in color. When comparing these two baseballs, they are clearly quite different from each other. But, which one is legal for game use? The answer is both of them. Baseball rule 3.01(c) doesn't specify how much mud to use when deglossing baseballs, nor does it state what color a rubbed baseball should be. All that it states is that the ball must be “properly rubbed so that the gloss is removed.” Since both of these baseballs are legal, there is no reason they wouldn't be used in the same game.

Although these variably colored baseballs are legal, the strategic use of a light-colored ball in some instances and a dark-colored ball in others can make an impact on the outcome of the baseball game. One must realize that a professional pitcher can easily throw the ball over 90 mph. At this speed, even the smallest things can affect the outcome of an “at bat.” One of the small things that affect an “at bat” is the batter's ability to see a light colored ball much easier than he can see a dark colored ball. A batboy smart enough and willing to exploit this inconsistency by bringing out baseballs to benefit his players can create competitive advantage for the home team.

While the baseball world recognizes that the manual mudding process creates various problems capable of affecting the outcome of games, no one has yet found a practical solution to standardize this process. Furthermore, it is contemplated that other deglossing needs exist, such as in the games of softball, volleyball, etc. Other more industrial deglossing needs are also contemplated. The subject invention addresses these needs.

### SUMMARY

Embodiments of the present invention described and claimed herein address the foregoing problems by application of a device that ensures uniform mudding of baseballs and deglossing of other objects. Various embodiments are described and recited herein. Although materials and methods similar or. equivalent to those described herein can be used in the practice of the invention, suitable materials and methods are described below. Furthermore, the materials, methods, and examples are illustrative and not intended to be limiting.

In one embodiment, a deglosser machine includes a horizontal base plate having a moveable, dome-shaped case with an applicator such as a chamois mounted therein. The chamois is used for receiving a liquid-mud mixture or deglossing agent and applying the agent to a baseball. Sponges or other mud-receiving and applying devices may be used in addition to, or in replacement of, a chamois in other embodiments. The baseball is received between a number of movable wheels. The wheels are used for spinning the ball in different axes for a predetermined amount of time. In this manner, the ball is deglossed and covered completely with a uniform amount of mud for consistent color and moisture.

The present invention provides many benefits over the prior art. Compared to manual application of deglossing mud, the deglosser machine significantly reduces variability in the coloring and moisture-content of mudded baseballs. Furthermore, by automating the deglossing process, significant time-savings are garnered as well.

These and other objects of the present invention win become apparent to those familiar with the mudding of baseballs and other deglossing needs when reviewing the following detailed description, showing novel construction, combination, and elements as herein described, and more particularly defined by the claims; it being understood that changes in the embodiments to the herein disclosed invention are meant to be included as coming within the scope of the claims, except insofar as they may be precluded by the prior art.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a perspective view of an exemplary embodiment of a deglosser machine, showing both the top and side.

FIG. 2 illustrates a top view of an exemplary embodiment of a deglosser machine.

FIG. 3 illustrates a cross sectional side view of an exemplary embodiment of a deglosser machine, highlighting the components below the base plate.

FIG. 4 illustrates exemplary operations for performing a deglossing of an object.

### DETAILED DESCRIPTION

A deglosser machine is described. In one embodiment, the deglosser machine is configured to degloss baseballs. Other embodiments wherein the machine is configured to degloss other objects are contemplated. For example, the deglosser can apply a deglossing agent to softballs, a cleaning agent to volleyballs, or a grip-enhancing agent to footballs (or other combinations of agents and objects). In another embodiment, the deglosser has: a reservoir that holds the deglossing agent (or any other agent), a means of automatically applying the agent to an object, a means of automatically manipulating the object and/or the agent to ensure uniform application of the agent to the object, and a means of controlling the operation(s) of the deglosser.

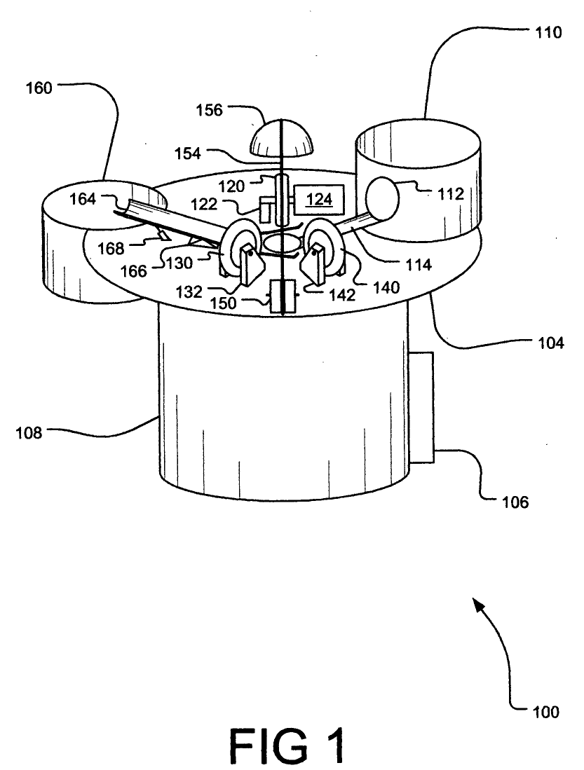

FIG. 1 illustrates a perspective view, showing both the top and side, of an exemplary embodiment of a deglosser machine 100. The primary components displayed in FIG. 1 include the base plate 104; the controls 106; the agent reservoir 108; the input hopper 110; the manipulators 120, 130, and 140; the applicator subassembly 150, 154, and 156; and the output hopper 160. As described throughout, a deglosser 100 acts upon one or more objects. The objects are not shown in any of the Figures as said objects can vary in size, shape, etc. However, for illustrative purposes only, a round ball such as a baseball can be pictured as the object in question throughout the following descriptions.

The base plate 104 illustrated in FIG. 1 is circular in shape. In other embodiments, the base plate 104 can be square, rectangular, triangular, or any other shape. The base plate 104 holds, or attaches to, many of the other primary components. For example, in the embodiment shown in FIG. 1, the input hopper 110 is illustrated as resting upon the base plate 104. The input hopper 110 is used as a receptacle to hold one or more objects that are waiting to be input into the deglosser 100.

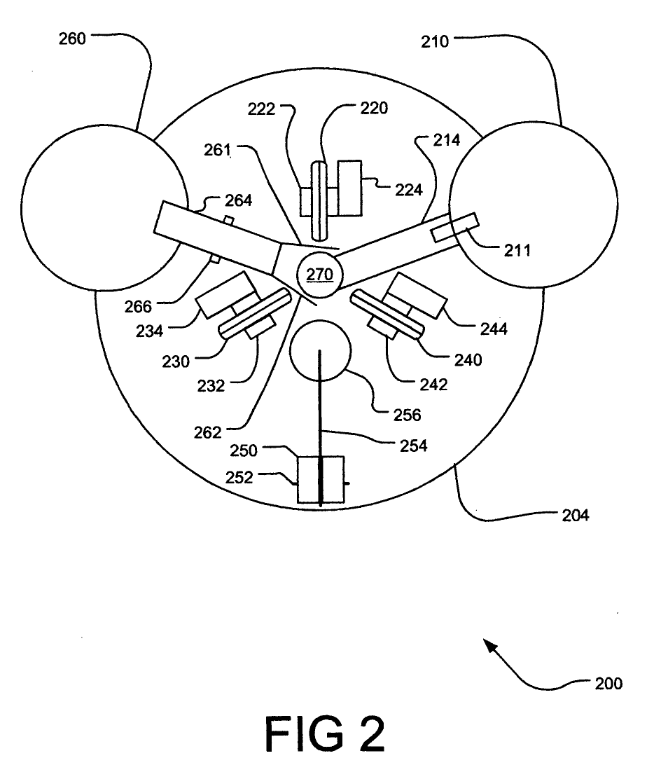

The input hopper 110 has an output port 112 that allows objects to move from the input hopper 110 to the input chute 114. A flow control (not shown in FIG. 1, see FIG. 2 flow control 211) operates to ensure that objects flow smoothly from the input hopper 110 through the deglosser 100 at the appropriate time. The input chute 114 guides an object from the input hopper 110 into the deglossing position (not labeled in FIG. 1, see FIG. 2 deglossing position 270).

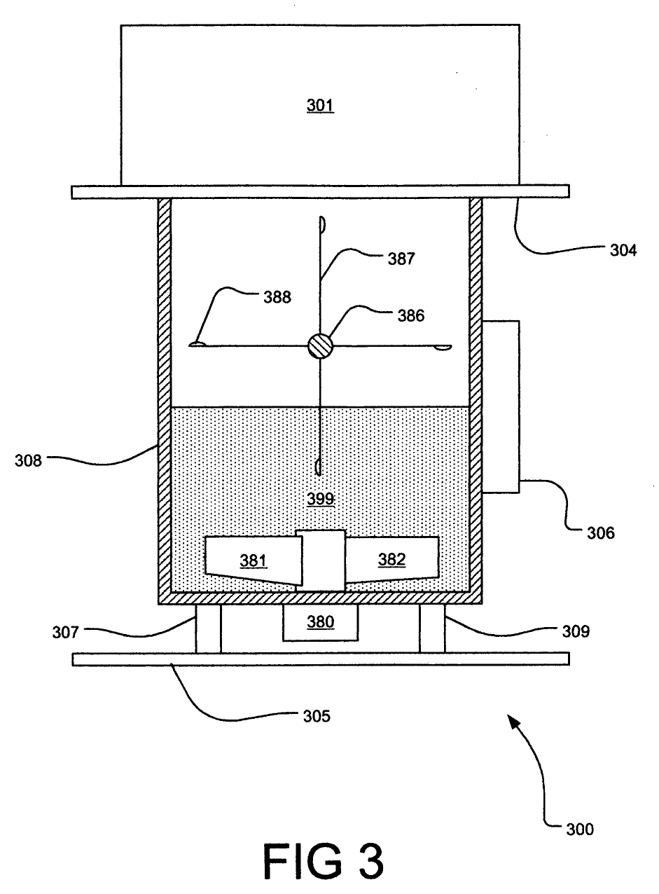

The deglossing position is generally centered between the manipulators 120, 130 and 140. In the embodiment shown in FIG. 1, the manipulators 120, 130 and 140 consist of three wheels positioned on the top surface of the base plate 104 in a plane at 120 degrees, 240 degrees and 360 degrees in a circle around the deglossing position. In other embodiments, differing numbers, locations and types of manipulators 120, 130 and 140 are contemplated. The manipulators 120, 130 and 140 work to reposition the object during the deglossing operation so that the agent (not shown in FIG. 1, see FIG. 3 agent 399) is relatively uniformly applied to the object. In another embodiment, the object remains relatively static and the agent is applied from multiple angles/locations onto the object in order to ensure relative uniformity in application of the agent to the object.

In the embodiment illustrated in FIG. 1, after the object comes to rest in the deglossing position 270, the applicator subassembly 150, 154 and 156 is lowered to at least partially encase the object from above. In one embodiment, the applicator subassembly 150, 154 and 156 is made up of a movable, dome-shaped case 156 attached to one end of an applicator arm 154. The other end of the applicator arm 154 is attached to the applicator actuator 150. The applicator actuator 150 controls the movement of the applicator arm 154 and case 156. In another embodiment, the case 156 is interchangeable and shaped to conform to whatever type of object is to be deglossed.

Once the applicator case 156 is positioned in proximity to the object, a first manipulator 120 contacts the object. The first manipulator 120 is supported by the first support 122 on one side of the manipulator 120 and by the first motor 124 on the other side. The first motor 124 activates and the first manipulator 120 begins to spin. The spinning of the first manipulator 120 causes the object to rotate on a first horizontal axis. As the object spins, the agent 399 is applied. In one embodiment, the agent 399 is applied to the case 156 and then the case 156 reapplies the agent 399 to the object. In another embodiment, the agent 399 is applied directly to the object and the case 156 acts to assist in the relatively uniform application of the agent 399 to the surface of the object. In this embodiment, the agent 399 can be applied via the hole in the base plate 104 that is located at the deglossing position 270 (also referred to as the deglossing position hole 270) and allows access to the agent reservoir 108.

In another embodiment, the agent 399 is pumped through the applicator arm 154 and into the case 156 where it is then applied to the object. In any embodiment, the case 156 can contain an applicator such as a chamois, sponge, or other similar article or material to assist in the relatively uniform distribution of the agent 399 to the object. Such materials work to absorb a portion of any excess agent 399 that is applied to the object and redistribute it to areas of the object to which not enough agent 399 has been applied.

After the first manipulator 120 finishes spinning (as determined by the controls 106)—a spin-time of approximately ten seconds is often sufficient—then the second motor (not shown in FIG. 1, see FIG. 2 second motor 234) begins to spin. The second manipulator 130 is supported by the second support 132 on one side of the second manipulator 130 and by the second motor 234 on the other side. The spinning of the second motor 234 activates the second manipulator 130 and it begins to spin. The spinning of the second manipulator 130 causes the object to rotate on a second horizontal axis. As the object spins, the agent 399 is applied. The various application methods described above in reference to the first manipulator 120 are applicable to the second manipulator 130 as well.

After the second manipulator 130 finishes spinning (as determined by the controls 106)—a spin-time of approximately ten seconds is often sufficient—then the third motor (not shown in FIG. 1, see FIG. 2 third motor 244) begins to spin. The third manipulator 140 is supported by the third support 142 on one side of the third manipulator 140 and by the third motor 244 on the other side. The spinning of the third motor 244 activates the third manipulator 140 and it begins to spin. The spinning of the third manipulator 140 causes the object to rotate on a third horizontal axis. As the object spins, the agent 399 is applied. The various application methods described above in reference to the first manipulator 120 are applicable to the third manipulator 140 as well.

In an alternate embodiment, only a first motor 124 is used. It is connected to all the manipulators 120, 130 and 140 and can spin them each independently. In yet other embodiments, a plurality of motors are used.

Once all the manipulators 120, 130 and 140 are finished with their tasks, the applicator actuator 150 operates to move the case 156 and release the object. The object output subassembly 160, 261, 262, 164, 166 and 168 is then activated. The first to act is the output actuator 168. The output actuator 168 repositions the output chute 164 causing the output fingers (not labeled in FIG. 1, see FIG. 2 first output finger 261 and second output finger 262) to engage the object and lift it above the plane of the base plate 104. The object then travels down the output chute 164 and is deposited into the output hopper 160. In the embodiment shown in FIG. 1, the output actuator 168 pulls down on one end of the output chute 164 (the end closest to the output hopper 160) and since the output chute 164 is resting on a fulcrum 166, the end of the output chute 164 containing the output fingers 261 and 262 is pushed up. This action lifts the object and directs it into the output hopper 160. In other embodiments, other types of output actuators 168 are contemplated as are other means of automatically moving the object from the deglossing position hole 270 to the output hopper 160.

The deglosser 100 shown in FIG. 1 can be configured to automatically operate on a number of objects placed in the input hopper 110. However, in an alternate embodiment, the deglosser 100 can lack the input hopper 110, the output port 112 and the input chute 114 and the object would simply be placed in the deglossing position 270 manually by the user. In another embodiment, the deglosser 100 can lack the output hopper 160, the output chute 164, the output actuator 168, the fulcrum 166, and the output fingers 261 and 262 and the object would simply be removed from the deglossing position 270 manually by the user once the operation is complete. In yet other embodiments, a plurality of the components listed above are lacking and a user simply handles manually whatever tasks those components which are lacking would normally complete.

The controls 106 can be anything from a simple on/off switch, to complex timing algorithms that automate the deglossing of various types and numbers of objects. Furthermore, the controls can communicate the status of the deglosser 100 to the user via LED(s), LCD(s), other displays, etc. In yet other embodiments, the controls 106 can be fully interactive allowing the user to set, supervise and modify-on-the-fly any setting or combination of settings for the deglosser 100.

The agent reservoir 108 holds the agent (not shown in FIG. 1, see FIG. 3 agent 399). The agent 399 can be deglossing agent for baseballs, e.g., mud. In other embodiments, the agent 399 can be a cleaning agent, a grip-enhancing agent, a whitening agent, etc. In yet other embodiments, combinations of agents can be used. The functions within the agent reservoir 108 are described in more detail in reference to FIG. 3.

FIG. 2 illustrates a top view of an exemplary embodiment of a deglosser machine 200. The deglosser 200 embodied in FIG. 2 functions similarly to those embodiments described in the detailed description of FIG. 1. Nothing in the following description of FIG. 2 should be construed as limiting the deglosser 200 to less than that described in the detailed description of FIG. 1. As one example, a user can operate the deglosser 200 in the following manner. First, a user adds a plurality of objects (in this case, baseballs) to the input hopper 210. The user then operates the controls 106 to activate the deglosser 200. The flow control 211 activates. In one embodiment, the flow control 211 is a star gear (similar to that commonly used to feed gumballs from a gumball machine) that allows only one baseball to feed into the input chute 214 at a time (the flow control 211 will not feed a second baseball into the input chute 214 until the first baseball has been placed in the output hopper 260). In another embodiment, the flow control 211 comprises a trap-door and finger system wherein as a first finger releases a first baseball into the input chute 214, a second finger comes up behind the first baseball and restrains the other baseballs from exiting the input hopper 210. Other means of implementing a flow control 211 that are known in the art may be utilized.

Navigation of the first baseball down the input chute 214 can be assisted by gravity in one embodiment In another embodiment, a conveyor belt, cog system, or some other mechanical feeding means can be utilized. Once the first baseball has entered the deglossing position 270 it comes to rest. Then, the applicator actuator 250 acts upon the applicator arm 254. The applicator arm 254 is connected to the applicator actuator 250 by the applicator pin 252 as well as the actuator connector (not shown). The applicator arm 254 pivots on the applicator pin 252 when the actuator connector moves the arm 254 up and down. In alternate embodiments, the actuator 250 uses other means to move the arm 254.

The applicator arm 254 drops down, causing the applicator case 256 to at least partially engage the baseball and hold it in the deglossing position 270. The bottom of the baseball protrudes through the deglossing position hole 270 in the base plate 204 and into the agent reservoir 108. Deglossing agent 399 is sprayed directly onto the bottom of the baseball. The first motor 224 begins to spin, causing the first manipulator 220 to spin. The first manipulator 220 is supported by the first support 222 on one side and the first motor 224 on the other. The spinning of the first manipulator 220 causes the first baseball to spin on its first horizontal axis. The spinning of the first baseball causes the bottom of the baseball to spin up and into contact with the applicator case 256. The case 256 helps to evenly distribute the agent 399 that was applied to the bottom of the baseball. As the baseball continues to spin, more agent 399 is applied to whatever portion of the baseball is protruding through the deglossing position hole 270 into the agent reservoir 108.

Once the first manipulator 220 has finished the second manipulator 230 acts. Deglossing agent 399 continues to be applied directly to the bottom of the baseball. The second motor 234 begins to spin, causing the second manipulator 230 to spin. The second manipulator 230 is supported by the second support 232 on one side and the second motor 234 on the other. The spinning of the second manipulator 230 causes the first baseball to spin on its second horizontal axis. The spinning of the first baseball causes the bottom of the baseball to spin up and into contact with the applicator case 256. The case 256 helps to evenly distribute the agent 399 that was applied to the bottom of the baseball. As the baseball continues to spin, more agent 399 is applied to whatever portion of the baseball is protruding through the deglossing position hole 270 into the agent reservoir 108.

Once the second manipulator 230 has finished the third manipulator 240 acts. Deglossing agent 399 continues to be applied directly to the bottom of the baseball The third motor 244 begins to spin, causing the third manipulator 240 to spin. The third manipulator 240 is supported by the third support 242 on one side and the third motor 244 on the other. The spinning of the third manipulator 240 causes the first baseball to spin on its third horizontal axis. The spinning of the first baseball causes the bottom of the baseball to spin up and into contact with the applicator case 256. The case 256 helps to evenly distribute the agent 399 that was applied to the bottom of the baseball. As the baseball continues to spin, more agent 399 is applied to whatever portion of the baseball is protruding through the deglossing position hole 270 into the agent reservoir 108.

During the actions of each of the first, second and third manipulators 220, 230 and 240, the agent 399 is relatively uniformly distributed onto the surface of the first baseball by contact with the case 256. The case 256 may contain an applicator such as a chamois, sponge, or other similar material that can enhance the uniform distribution of the agent 399 onto the baseball.

Once the third manipulator 240 has finished, the output actuator 168 acts upon the output chute 264, pulling down the end of the output chute 264 nearest the output hopper 260. Since the output chute 264 is resting on a fulcrum 266, the end of the output chute 264 nearest the deglossing position 270 is raised up. This upwards motion causes the output fingers 261 and 262 to engage the first baseball and lift it up. Gravity then causes the baseball to move down the output chute 264 and into the output hopper 260. Once the baseball has entered the output hopper 260, the flow control 211 is activated and a second baseball is fed from the input hopper 210 onto the input chute 214 and the process is repeated until no more baseballs are detected in the input hopper 210.

In one embodiment, a weight sensor is attached to the input hopper 210 to sense whether any objects remain in the input hopper 210. In another embodiment, a sensor on the flow control 211 determines whether any objects remain to be deglossed. In other embodiments, other means of sensing any remaining objects are utilized. In order for the input hopper 210 to gravity feed objects to the flow control 211, the bottom of the input hopper 210 can be shaped in a modified downwards-pointing cone directing objects onto the flow control 211. In yet another embodiment, automated means of directing objects onto the flow control 211 are used.

It should be noted that enhancements to the above functionality are contemplated. For example, an overflow-sensor can be attached to the output hopper 260 to shut down the deglosser 200 before an overflow situation occurs in the output hopper 260.

FIG. 3 illustrates a cross sectional side view of an exemplary embodiment of a deglosser machine 300, highlighting components below the base plate 304. The additional components shown in FIG. 3 include controls 306, agent reservoir 308, agent 399, support legs 307 and 309, floor plate 305, mixer motor 380, mixer blades 381 and 382, horizontal axle 386, a plurality of spokes 387, a plurality of scoops 388, and a safety cover 301.

The controls 306, agent reservoir 308, and agent 399 are described in more detail above. The agent reservoir 308 contains the agent 399. The controls 306 operate as described above and also can control all the functions described hereunder. The floor plate 305 provides a firm foundation for the deglosser 300. In other embodiments, a floor plate 305 may not be used or may be shaped differently from that illustrated in FIG. 3. The support legs 307 and 309 connect the reservoir 308 to the floor plate 305 and provide room for the mixer motor 380 to extend downwards from the reservoir body 308. The mixer motor 380 turns the mixer blades 381 and 382 which then rotate inside the reservoir 308 and thereby mix the agent 399, providing a consistent, well mixed mud (or other agent 399). The mixer blades 381 and 382 can be curved, shaped, or otherwise modified to more efficiently mix the agent 399. Additionally, the use of more or fewer blades is contemplated. Seals and bearings can be used to keep the agent 399 from leaking out the bottom of the agent reservoir 308 and into the mixer motor 380. Other means known in the art can also be utilized.

The horizontal axle 386 is rotated either by its own motor (not shown) or through connection to one of the other motors previously described. Gearing/transmissions and clutches may be used to disengage a multi-use motor from one use and apply it to another use. Multi-use motor systems may drive multiple actions concurrently. A plurality of spokes 387 are attached to the axle 386. Attached to each of the plurality of spokes 387 are one or more scoops 388. Rotation of the axle 386 causes the spokes 387 to rotate about the axle 386, thereby driving the plurality of scoops 388 down into the agent 399. As the scoops 388 come up out of the agent 399, they scoop up a portion of the agent 399. As the scoops 388 continue to rotate around the axle 386, they eject the agent 399 towards the deglossing position hole 270, thereby covering the bottom of whatever object is placed in the deglossing position 270. In another embodiment, a pump and nozzle system could be used in place of the axle 386, spokes 387 and scoops 388 in order to draw the agent 399 out of the reservoir 308 and apply it to the object. In yet another embodiment, the agent 399 could be transported to the case 256 and applied to the top of the object.

Finally, as shown in FIG. 3, a safety cover 301 can be utilized to cover all the moving parts on the base plate 304 and minimize the chance of any agent 399 being thrown off the object and into the surroundings of the deglosser 300.

The materials of which the deglosser 300 is constructed can be any appropriate materials known in the art including, but not limited to: plastics, rubbers, metals and alloys, fiberglass, ceramics, etc.

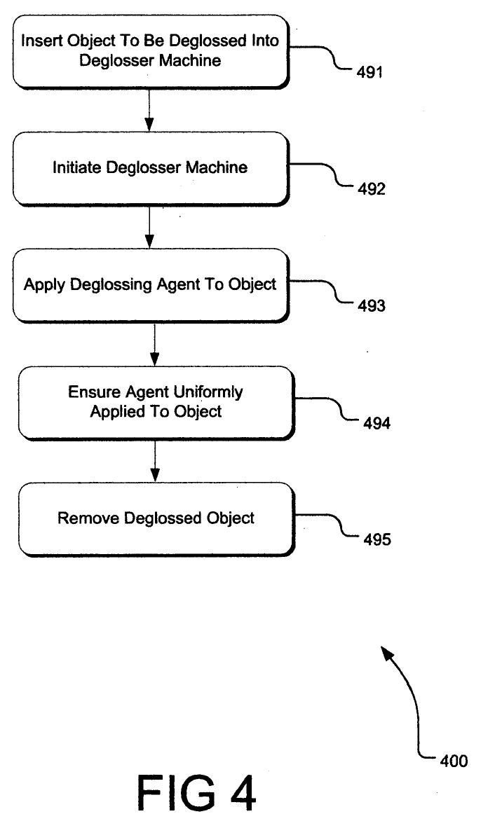

FIG. 4 illustrates exemplary operations for performing a deglossing of an object. The Insert Object To Be Deglossed Into Deglosser Machine operation 491 is relatively straightforward when an input hopper 210 is used. The user simply places one or more objects into the input hopper 210. When an input hopper 210 is not employed, the user must place the object(s) manually on the flow control 211, the input chute 214 or directly on the deglossing position hole 270 (depending which components are employed).

The Initiate Deglosser Machine operation 492 involves the user causing the deglosser 200 to become active. This can be as simply as turning on the deglosser 200, or can involve operating multiple settings/switches/etc. in the controls 306.

The Apply Deglossing Agent To Object operation 493 involves the deglosser 200 applying an agent 399 to an object. As discussed in detail above, application of an agent 399 to an object can be accomplished in many ways. Regardless of the means utilized (see above), the deglosser 200 handles this step automatically.

The Ensure Agent Uniformly Applied To Object operation 494 involves at least the application of the case 256 to the object in order to uniformly distribute the agent 399 on the object. In addition, the deglosser 200 can use sensors (such as a digital camera, a spectrophotomic curved surface analyzer, etc.) to examine the deglossed object and ensure it meets a certain set of minimum characteristics before moving the object to the output chute 264. In another embodiment, the deglosser 200 can automatically redirect objects that received a sub-standard deglossing to a rejects hopper or attempt to degloss such objects again.

The Remove Deglossed Object operation 495 is relatively straightforward when an output hopper 260 is used The user simply waits for the deglosser 200 to automatically move deglossed objects into the output hopper 260. When an output hopper 260 is not employed, the user must manually remove the object(s) from the output chute 264 or directly from the deglossing position hole 270 (depending on which output components are employed).

The descriptions above illustrate exemplary components that can make up an exemplary deglosser machine. The above specification, examples and data provide a description of the structure and use of exemplary embodiments of the invention. Since many embodiments of the invention can be made without departing from the spirit and scope of the invention, the invention resides in the claims, including those hereinafter appended. Furthermore, structural features of the different embodiments may be combined in yet another embodiment without departing from the recited claims. Other embodiments are therefore contemplated.

A set of embodiments of the invention described herein can be implemented as a method (see FIG. 4). The operations making up the embodiments of the invention described herein can be referred to variously as operations, steps, objects, or modules. Furthermore, it should be understood that operations may be performed in any order, unless explicitly claimed otherwise or a specific order is inherently necessitated by the claim language.

What is claimed is:

1. A deglosser, comprising:
a base plate having a plurality of manipulators arranged on the base plate so as to generally surround a deglossing position,
an applicator case in proximity to the deglossing position,
an agent reservoir holding an agent, and
a means of applying the agent to an object to be deglossed; wherein the object is placed in the deglossing position, the agent is applied to the object, the manipulators manipulate the object, and the applicator case distributes the agent across at least a desired portion of the object.

2. The deglosser of claim 1 wherein the means of applying the agent to the object comprises:
an axle placed within the agent reservoir,
a plurality of spokes extending out from the axle, and
a plurality of scoops attached to each of the plurality of spokes;
wherein rotation of the axle causes the plurality of spokes to move the plurality of scoops through the agent, the plurality of scoops gather the agent, and continued rotation of the axle causes the plurality of scoops to apply the agent to the object.

3. The deglosser of claim 1 wherein the means of applying the agent to the object comprises:
a pump,
a plurality of tubes, and
a plurality of nozzles; wherein the pump collects the agent from the agent reservoir and pushes the agent into the plurality of tubes, the tubes distribute the agent to the plurality of nozzles, and the plurality of nozzles apply the agent to the object.

4. The deglosser of claim 1 wherein the plurality of manipulators each comprises:
a motor, and
a wheel; wherein the motor turns the wheel and the wheel acts upon the object in order to manipulate the object.

5. The deglosser of claim 2 wherein the plurality of manipulators each comprises:
a motor, and
a wheel; wherein the motor turns the wheel and the wheel acts upon the object in order to manipulate the object.

6. The deglosser of claim 3 wherein the plurality of manipulators each comprises:
a motor, and
a wheel; wherein the motor turns the wheel and the wheel acts upon the object in order to manipulate the object.

7. The deglosser of claim 1 wherein the applicator case further comprises:
a housing having an inner surface and an outer surface, wherein the inner surface is shaped to at least partially encase the object; and
an applicator attached to the inner surface of the housing, wherein the applicator contacts the object.

8. The deglosser of claim 4 wherein the applicator case further comprises:
a housing having an inner surface and an outer surface, wherein the inner surface is shaped to at least partially encase the object; and
an applicator attached to the inner surface of the housing, wherein the applicator contacts the object.

9. The deglosser of claim 5 wherein the applicator case further comprises:
a housing having an inner surface and an outer surface, wherein the inner surface is shaped to at least partially encase the object; and
an applicator attached to the inner surface of the housing, wherein the applicator contacts the object.

10. The deglosser of claim 6 wherein the applicator case further comprises:
a housing having an inner surface and an outer surface, wherein the inner surface is shaped to at least partially encase the object, and
an applicator attached to the inner surface of the housing, wherein the applicator contacts the object.

11. A deglosser, comprising:
a base plate having a plurality of manipulators arranged on the base plate so as to generally surround a deglossing position,
an applicator case in proximity to the deglossing position,
an agent reservoir holding an agent,
an application means for applying the agent to an object to be deglossed,
an input hopper,
a flow control,
an input chute,
an output chute,
an output actuator, and
an output hopper; wherein the input hopper receives a plurality of objects to be deglossed, the flow control moves a first object out of the input hopper and onto the input chute, the input chute directs the first object to the deglossing position, the applicator case at least partially encases the first object, the application means gathers the agent from the agent reservoir and applies the agent to the first object, the plurality of manipulators manipulate the first object causing the applicator case to distribute the agent across at least a desired portion of the first object, the output actuator actuates thereby moving the first object to the output chute, and the output chute directs the first object into the output hopper.

12. The deglosser of claim 11 wherein the means of applying the agent to the first object comprises:
an axle placed within the agent reservoir,
a plurality of spokes extending out from the axle, and
a plurality of scoops attached to each of the plurality of spokes;
wherein rotation of the axle causes the plurality of spokes to move the plurality of scoops through the agent, the plurality of scoops gather the agent, and continued rotation of the axle causes the plurality of scoops to apply the agent to the first object.

13. The deglosser of claim 11 wherein the means of applying the agent to the first object comprises:
a pump,
a plurality of tubes, and
a plurality of nozzles; wherein the pump collects the agent from the agent reservoir and pushes the agent into the plurality of tubes, the tubes distribute the agent to the plurality of nozzles, and the plurality of nozzles apply the agent to the first object.

14. The deglosser of claim 11 wherein the plurality of manipulators each comprises:
a motor, and
a wheel; wherein the motor turns the wheel and the wheel acts upon the first object in order to manipulate the first object.

15. The deglosser of claim 12 wherein the plurality of manipulators each comprises:
a motor, and
a wheel; wherein the motor turns the wheel and the wheel acts upon the first object in order to manipulate the first object.

16. The deglosser of claim 13 wherein the plurality of manipulators each comprises:
a motor; and
a wheel; wherein the motor turns the wheel and the wheel acts upon the first object in order to manipulate the first object.

17. The deglosser of claim 11 wherein the applicator case further comprises:
a housing having an inner surface and an outer surface, wherein the inner surface is shaped to at least partially encase the first object; and
an applicator attached to the inner surface of the housing, wherein the applicator contacts the first object.

18. The deglosser of claim 14 wherein the applicator case further comprises:
a housing having an inner surface and an outer surface, wherein the inner surface is shaped to at least partially encase the first object; and
an applicator attached to the inner surface of the housing, wherein the applicator contacts the first object.

19. The deglosser of claim 15 wherein the applicator case further comprises:
a housing having an inner surface and an outer surface, wherein the inner surface is shaped to at least partially encase the first object; and
an applicator attached to the inner surface of the housing, wherein the applicator contacts the first object.

20. A method of deglossing an object, the method comprising:
inserting an object to be deglossed into a deglossing machine;
initiating the deglossing machine;
applying a deglossing agent to the object;
ensuring the agent is uniformly applied to the object; and
removing the object.
